(19) United States
(12) Patent Application Publication
(10) Pub. No.: US 2006/0187420 A1
(43) Pub. Date: Aug. 24, 2006

(54) Projector and cooling module of the same

(75) Inventors: Hung-Jen Wei, Nantou City (TW); Shu-Mei Chien, Bade City (TW); Chun-Ming Shen, Banciao City (TW); Sheng-Chang Lu, Magong City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: BENQ Corporation

(21) Appl. No.: 11/356,333

(22) Filed: Feb. 16, 2006

(30) Foreign Application Priority Data
Feb. 22, 2005 (TW) 094105292

(51) Int. Cl. G03B 21/16

(52) U.S. Cl. 353/61

(57) ABSTRACT

A cooling module of a projector is provided. The cooling module is disposed in a housing. The projector includes several heat generating components and the housing has a first side and a second side. The cooling module includes a first cooling path, a second cooling path and a first fan. The second cooling path is adjacent to the first cooling path. Between the first cooling path and the second cooling path are several heat generating components. The first fan is disposed on the second side of the housing. The first fan leads part of the heat generated by the heat generating components to flow along the first cooling path and leads another part of the heat generated by the heat generating components to flow along the second cooling path.

This application claims the benefit of Taiwan application Serial No. 94105292, filed Feb. 22, 2005, the subject matter of which is incorporated herein by reference.

### BACKGROND OF THE INVENTION

1. Field of the Invention

The present invention relates to a projector and a cooling module of the same, and more particularly, to a projector and a cooling module of the same with two cooling paths.

2. Description of the Related Art

A projector is widely used in schools, offices, meeting rooms, and homes for projecting slides, photos, or even films. It is very popular for its advantage of projecting from a small area to a large screen for lots of people viewing at the same time.

A prior projector includes: a housing, an optical engine, a light source and a fan. A light beam emitted from the light source is guided to the optical engine, and the optical engine leads the light beam via a camera lens to project images on a screen. The fan is used for cooling heat generating components such as the optical engine and the light source which are disposed in the housing, and preventing the light source and the electronic devices in the optical engine from damage by high temperature.

However, the cooling method for the prior projector is using the fan to exhaust the air flow by only a single cooling path for reducing the temperature of the projector. And the air flow then flows along the single cooling path naturally to the areas with small air resistance. Therefore, the air flow could not pass to all the heat generating components if some heat generating components are not disposed along the cooling path.

Reference is made to FIG. 1, which depicts a perspective view of a prior projector. The projector 100 includes: an optical engine 101, a power supply 103, a light source 105 and a fan 107. The fan 107 is used for cooling, and an air flow 110 herein could not pass the power supply 103 because of the air flow 110 choosing the shortest cooling path naturally. Therefore, the power supply 103 would be damaged because of high temperature, and the lifetime of the projector 100 would be reduced.

### SUMMARY OF THE INVENTION

It is an aspect of the present invention to provide a projector and a cooling module of the same. The cooling module is used for cooling all of the heat generating components in the projector, so as to improve the performance and efficiency of the projector and extending the lifetime of the projector.

According to the aforementioned aspect of the present invention, a cooling module for a projector is provided. The cooling module is disposed in a housing of the projector. The projector includes a plurality of heat generating components, and the housing has a first side and a second side. The cooling module comprises: a first cooling path, a second cooling path, and a first fan. The second cooling path is adjacent to the first cooling path, and the first cooling path and the second cooling path are separated by part of the heat generating components. The first fan is disposed on the second side of the housing. The first fan leads a part of the heat generated by the heat generating components via the first cooling path, and leads another part of the heat generated by the heat generating components to flow along the second cooling path.

According to the aforementioned aspect of the present invention, a projector is provided. The projector comprises: a housing, a plurality of heat generating components, and a cooling module. The housing has a first side and a second side. The heat generating components are disposed in the housing. The cooling module comprises: a first cooling path, a second cooling path, and a first fan. The second cooling path is adjacent to the first cooling path, and the first cooling path and the second cooling path are separated by part of the heat generating components. The first fan is disposed on the second side of the housing. The first fan leads a part of the heat generated by the heat generating components to flow along the first cooling path, and leads another part of the heat generated by the heat generating components to flow along the second cooling path.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 (Prior Art) depicts a top plan view showing a projector of the prior art;

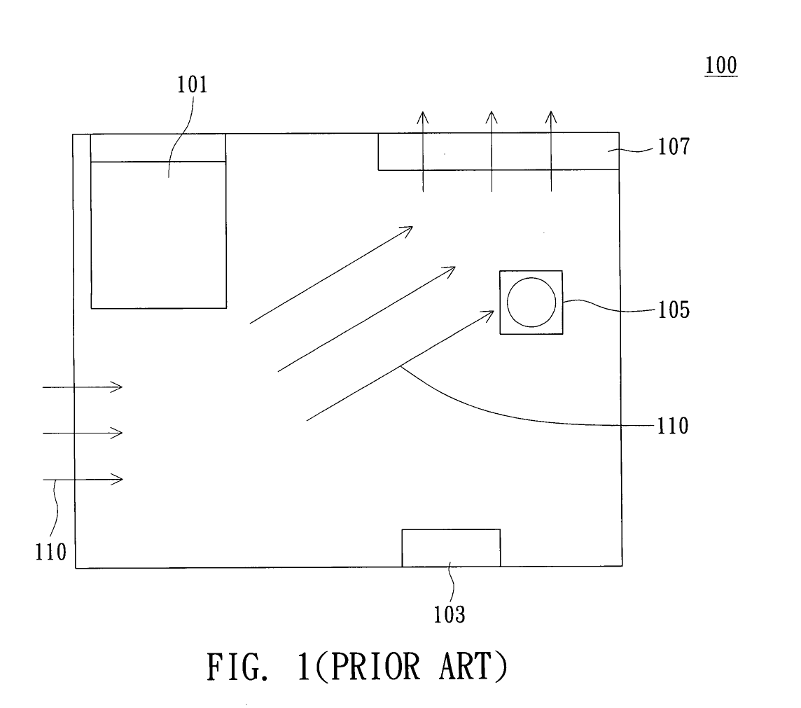

FIG. 2A depicts a schematic diagram showing a projector in accordance with a first embodiment of the present invention;

FIG. 2B depicts a top plan view showing components inside the projector in accordance with the first embodiment of the present invention;

FIG. 3A depicts a schematic diagram showing a projector in accordance with a second embodiment of the present invention;

FIG. 3B depicts a top plan view showing components inside the projector in accordance with the second embodiment of the present invention; and

FIG. 3C illustrates a side view showing a projector from the second side in accordance with FIG. 3A.

### DETAILED DESCRIPTION OF THE PREFERRED EMBODIMENT

### FIRST EMBODIMENT

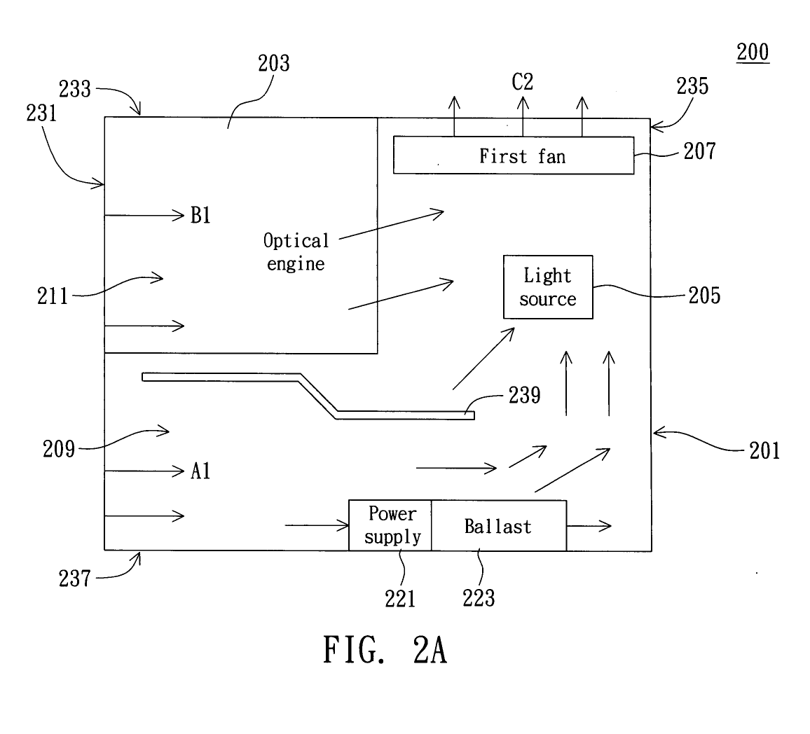

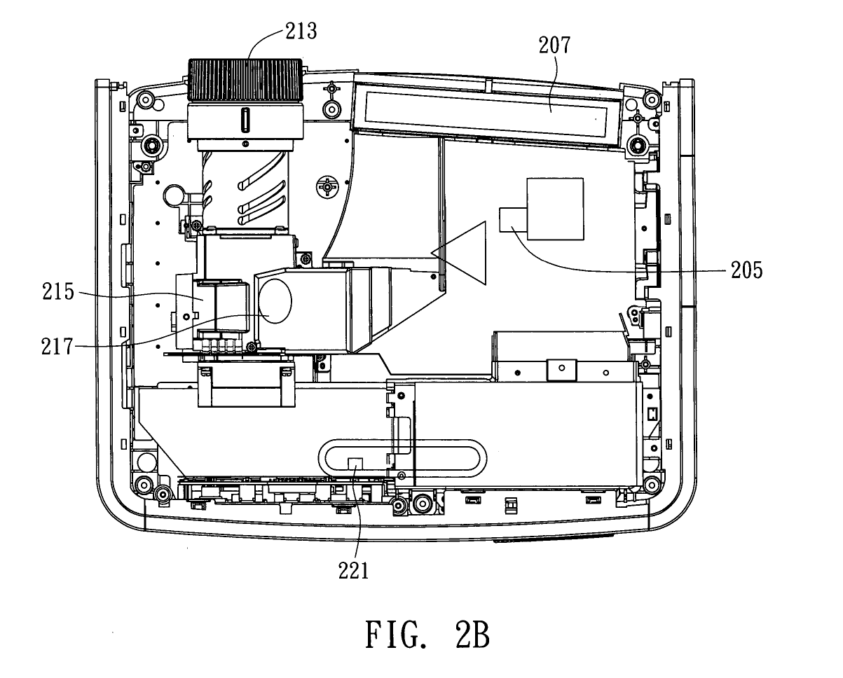

Reference is made to FIG. 2A, which depicts a schematic diagram showing a projector in accordance with a first embodiment of the present invention. The projector 200 includes: a housing 201, heat generating components, and a cooling module. The housing 201 has a first side 231, a second side 233, a third side 235, and a fourth side 237, wherein the first side 231 corresponds to the third side 235, and the second side 233 corresponds to the fourth side 237. The heat generating components include: an optical engine 203, a light source 205, a power supply 221, and a ballast 223. The cooling module includes: a first cooling path 209, a second cooling path 211 and a first fan 207. The second cooling path 211 is adjacent to the first cooling path 209, and part of the heat generating components are disposed between the first cooling path 209 and the second cooling path 211. That is, the first cooling path 209 and the second cooling path 211 are separated by parts of the heat generating components. Furthermore, the first cooling path 209 and the second cooling path 211 of the present invention could be formed and separated by providing a plate 239 instead of using the heat generating components. The optical engine 203 of the heat generating components is disposed on the second cooling path 211. The power supply 221 and the ballast 223 of the heat generating components are disposed on the first cooling path 209. And the light source 205 of the heat generating components is preferred disposed on the cross point where the first cooling path 209 and the second cooling path 211 intersect.

Referring both to FIGS. 2A and 2B, FIG. 2B depicts a top plan view showing components inside the projector in accordance with the first embodiment of the present invention. The optical engine 203 includes: a camera lens 213, a digital micromirror device (DMD) 215, lens 217 and a color wheel (not shown). The optical engine 203 is disposed adjacent to both the first side 231 and the second side 233. The optical engine 203 is used for leading light beam emitted from the light source 205. The light beam emitted from the light source 205 passes through a light path formed sequentially by the color wheel, lens 217 and the digital micromirror device (DMD) 215, and the light beam pass the camera lens 213 and then projects to the screen. As shown in FIG. 2B, the first cooling path 209 and the second cooling path 211 are separated by the optical engine 203. While the fan 207 is turned on, an air flow A1 is generated in the first cooling path 209, and another air flow B1 is generated in the second cooling path 211. The air flow A1 is used for taking away the heat generated by the power supply 221 and the ballast 223 and for reducing the temperature of the first cooling path 209. The air flow B1 is used for taking away the heat generated by the optical engine 203, especially taking away the heat generated by digital micromirror device (DMD) 215, which is usually with the highest temperature. In addition, the light source 205, such as a discharge lamp, has the highest temperature of all the heat generating components. The light source 205 is preferably disposed on the cross point where the first cooling path 209 and the second cooling path 211 intersect, so that the first cooling path 209 and the second cooling path 211 could work together to reduce the temperature of the light source 205.

### SECOND EMBODIMENT

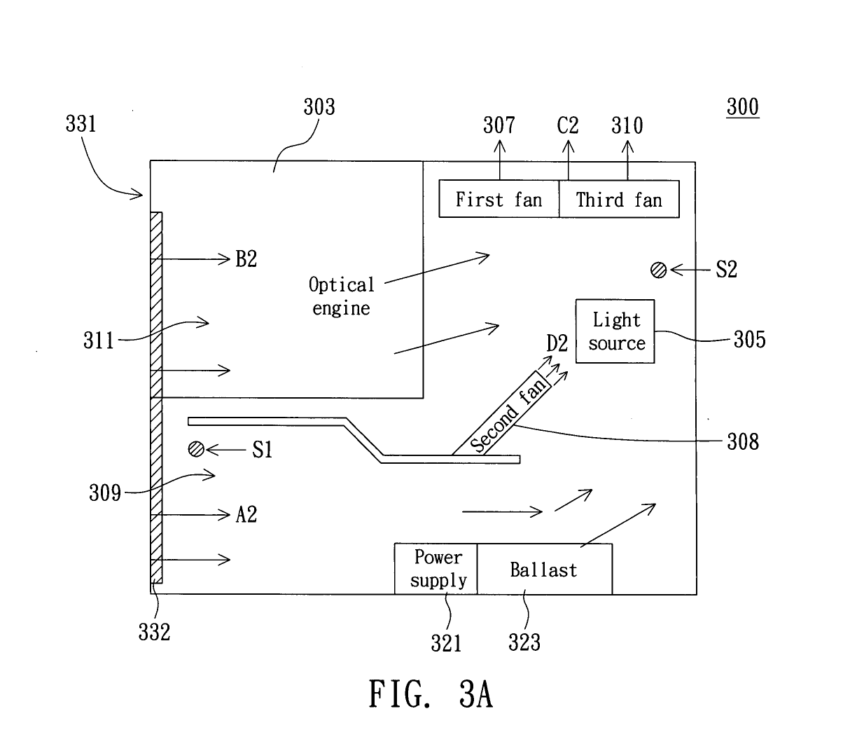

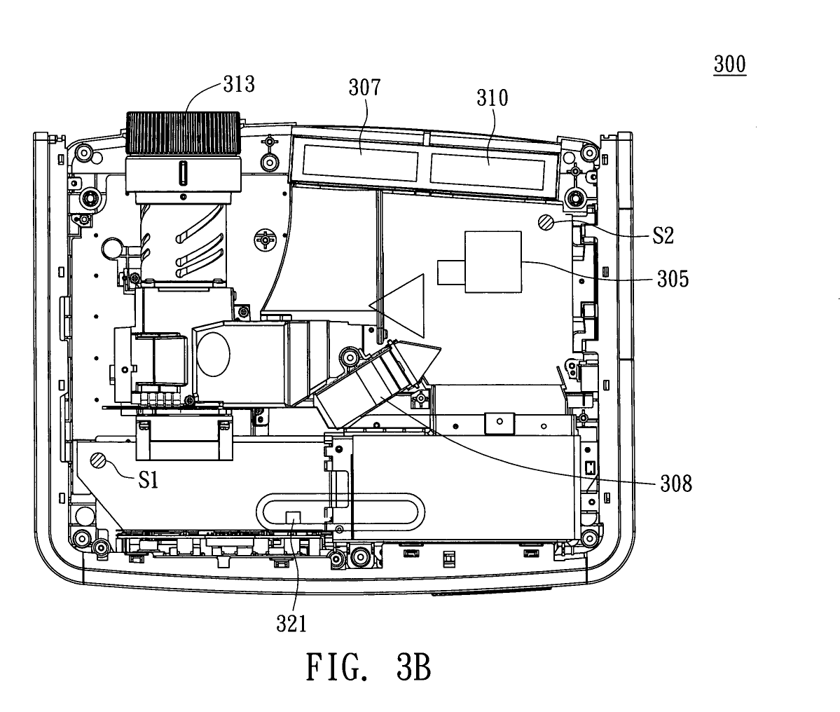

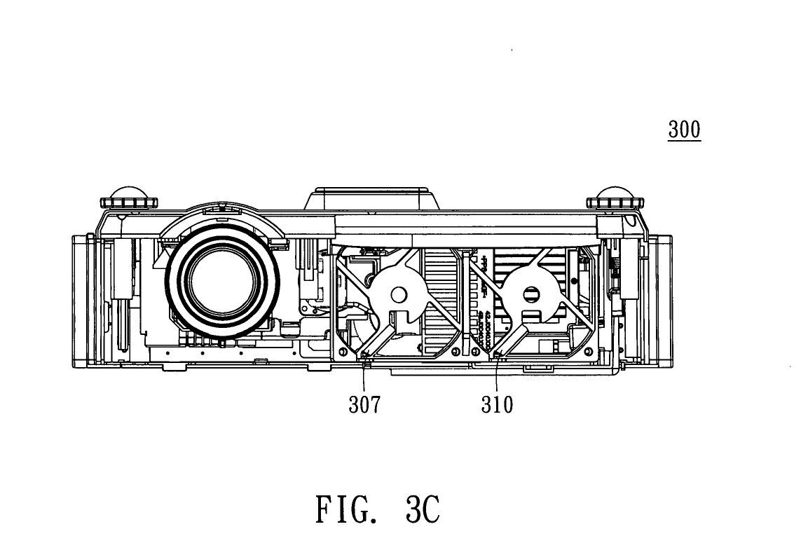

Referring both to FIGS. 3A and 3B, FIG. 3A depicts a schematic diagram showing a projector in accordance with a second embodiment of the present invention, and FIG. 3B depicts a top plan view showing components inside the projector in accordance with the second embodiment of the present invention. Compared with the first embodiment, there is a filter 332 disposed on the first side 331 for preventing dust and dirt from entering the projector 300 in the second embodiment. A thermal sensor S1 is disposed on the first cooling path 309 adjacent to the first side 331, wherein the thermal sensor S1 is a temperature detector for example, for detecting the temperature along the first cooling path 309. A second thermal sensor S2 could be further disposed on the first cooling path 309 or the second cooling path 311. When the first thermal sensor S1 detects the temperature, the rotating speed of the first fan 307 is controlled by software to reduce the temperature. For example, the higher the detecting temperature is, the faster the rotating speed of the first fan 307 is. If the temperature of the first cooling path 309 or the second cooling path 311 is too high, the projector 300 could be controlled to turn off by software for protecting the inside components. The second thermal sensor S2 could be disposed anywhere and is used for detecting temperature for warning user to change or clean the filter 332. The warning message could be shown on the projecting image.

Referring to FIGS. 3A, 3B and 3C, FIG. 3C illustrates a side view showing a projector from the second side in accordance with FIG. 3A. A second fan 308 is used for supporting the first fan 307 for further cooling the light source 205. The air flow D2 from the second fan 308 is shown in FIG. 3A. In the second embodiment, the first fan 307 could be replaced by two small fans, including the first fan 307 and a third fan 310, which fulfill the same cooling function as the first fan 307 shown in FIG. 3C.

According to the aforementioned embodiments, the present invention provides a projector and a cooling module of the same. The cooling module includes two cooling paths for cooling all heat generating components on the two cooling paths. The present invention eliminates the prior problem that air flow could not flow all over the heat generating components because the air flow flows only to the areas with small air resistance. For example, prior power supply and ballast are usually damaged because air flow fails to pass by for cooling the prior power supply and ballast, and prior ballast usually burns out and needs users changing frequently. In addition, a filter is used for preventing the projector from dust and dirt and reducing the temperature inside the projector in the second embodiment. The present invention combines two cooling paths, thermal sensors, a second fan and a third fan, for further reducing the inside temperature of the projector, improving the performance and efficiency of the electronic components and extending the lifetime of the electronic components inside the projector.

As is understood by a person skilled in the art, the foregoing embodiments of the present invention are illustrated of the present invention rather than limiting of the present invention. It is intended that various modifications and similar arrangements be included within the spirit and scope of the appended claims, the scope of which should be accorded the broadest interpretation so as to encompass all such modifications and similar structure.

What is claimed is:

1. A cooling module for a projector, the cooling module disposed in a housing of the projector, the projector includes a plurality of heat generating components, the housing having a first side and a second side, the cooling module comprising:
a first cooling path;
a second cooling path, adjacent to the first cooling path, the first cooling path and the second cooling path being separated by part of the heat generating components; and
a first fan, disposed on the second side of the housing, the first fan leading a part of heat generated by the heat generating components to flow along the first cooling path, and leading another part of the heat generated by the heat generating components to flow along the second cooling path.

2. The cooling module according to claim 1, the heat generating components comprising:
a power supply, disposed on the first cooling path;
an optical engine, substantially disposed on the second cooling path, the power supply providing power to the optical engine; and
a light source, the power supply providing power to the light source, the light source substantially disposed on the first cooling path.

3. The cooling module according to claim 1, further comprising a second fan, wherein the second fan is disposed on the second cooling path, and is used for leading heat generated by the light source to flow along the first cooling path and the second cooling path.

4. The cooling module according to claim 1, further comprising a third fan, adjacent to the first fan, and co-working with the first fan for cooling.

5. The cooling module according to claim 3, the heat generating components further comprising a ballast, adjacent to the power supply, the ballast and the power supply generating heat.

6. The cooling module according to claim 1, further comprising a first thermal sensor, adjacent to the first side of the housing, wherein the higher temperature the first thermal sensor detects, the faster the rotating speed of the first fan is for cooling.

7. The cooling module according to claim 1, further comprising a filter, for preventing dust and dirt from entering the first side of the housing and increasing the temperature of the projector.

8. The cooling module according to claim 7, further comprising a second thermal sensor, disposed on the first cooling path or the second cooling path, wherein when the second thermal sensor detects a high temperature, the second thermal sensor warns user to change or clean the filter.

9. A projector, comprising:
a housing having a first side and a second side;
a plurality of heat generating components, disposed in the housing; and
a cooling module, comprising:
a first cooling path;
a second cooling path, the second cooling path adjacent to the first cooling path, and the first cooling path and the second cooling path being separated by part of the heat generating components; and
a first fan, disposed on the second side of the housing, the first fan leading a part of the heat generating by the heat generating components to flow along the first cooling path, and leading another part of the heat generating by the heat generating components to flow along the second cooling path.

10. The projector according to claim 9, wherein the heat generating components comprises:
a power supply, disposed on the first cooling path;
an optical engine, substantially disposed on the second cooling path, the power supply providing power to the optical engine; and
a light source, the power supply providing power to the light source, the light source substantially disposed on the first cooling path.

11. The projector according to claim 10, wherein the cooling module further comprises a second fan, disposed on the second cooling path, and used for leading heat generated by the light source to flow along the first cooling path and the second cooling path.

12. The projector according to claim 9, wherein the cooling module further comprises a third fan, adjacent to the first fan, and co-working with the first fan for cooling.

13. The projector according to claim 9, wherein the heat generating components further comprises a ballast, adjacent to the power supply, the ballast and the power supply generating heat.

14. The projector according to claim 9, wherein the cooling module further comprises a first thermal sensor, adjacent to the first side of the housing, and the higher temperature the first thermal sensor detects, the faster the rotating speed of the first fan is for cooling.

15. The projector according to claim 9, wherein the cooling module further comprises a filter, for preventing dust and dirt from entering the first side of the housing and increasing the temperature of the projector.

16. The projector according to claim 9, wherein the cooling module further comprises a second thermal sensor, disposed on the first cooling path or the second cooling path, wherein when the second thermal sensor detects high temperature, the second thermal sensor warns user to change or clean the filter.
